(19) United States
(12) Patent Application Publication
(10) Pub. No.: US 2002/0042331 A1
(43) Pub. Date: Apr. 11, 2002

(54) Paint roller core, cover and method of manufacture

(75) Inventors: Christina L. Fortner, Oak Creek, WI (US); Brian E. Woodnorth, Whitefish Bay, WI (US)

Correspondence Address: Todd A. Rathe, FOLEY & LARDNER, Firstar Center, 777 East Wisconsin Avenue, Milwaukee, WI, 53202-5367, US

(73) Assignee: Newell Operating Company.

(21) Appl. No.: 09/974,274

(22) Filed: Oct. 10, 2001

Related U.S. Application Data
(60) Provisional application No. 60/238,932, filed on Oct. 10, 2000.

(51) Int. Cl. B05C 17/02; B05C 1/08; B25F 5/02; B25F 5/00

(52) U.S. Cl. 492/13; 15/230.11; 15/230.12; 15/230.13; 492/48

(57) ABSTRACT

A paint roller cover includes a cylindrical core and a liquid applying medium coupled to the core. The core has an inner surface and an opposite outer surface. The core includes at least one gap between the inner surface and the outer surface.

### CROSS-REFERENCE TO RELATED PATENT APPLICATIONS

This application claims priority under 35 U.S.C. § 119(e) from U.S. Provisional Patent Application Serial No. 60/238,932 entitled PAINT ACCESSORIES INCLUDING PAINT ROLLER and filed on Oct. 10, 2000 by Brian E. Woodnorth, Christina L. Fortner and Darryl L. Kaminski, the full disclosure of which is hereby incorporated by reference.

### FIELD OF THE INVENTION

The subject matter of the invention relates to paint rollers and roller covers. In particular, the subject matter of the invention relates to a unique paint roller core, paint rollers including such a core, and methods for manufacturing the core.

### BACKGROUND

Paint roller covers typically include a relatively rigid cylindrical core having an outer surface with supports a paint or liquid applying medium such as a natural or synthetic fabric material (wool, polyester, etc.) or various other liquid absorbing and releasing materials such as foam, sponge, napped material and the like. Paint roller cores are typically formed from either cardboard or a thermoplastic material.

Cores formed from thermoplastic material are preferred due to the solvent resistance of the thermoplastic material utilized. Such paint roller cores formed from thermoplastic material are typically formed either by extruding a cylindrical or tubular shaped core or by spirally wrapping one or more ribbons, bands or plies about a cylindrical mandrel to form the cylindrical core. The multiple plies are typically adhered to one another by either applying an intermediate layer of liquid thermoplastic adhesive or by melting either one or both of the adjacent surfaces of the overlapping plies such that the plies fuse to one another. In a similar manner, the layer of fabric material or the paint applying medium is affixed to the core itself by applying a liquid thermoplastic adhesive between the core and the paint applying medium or by melting the outer surface of the core so as to fuse the core to the layer of paint applying medium. With such thermoplastic cores, it is extremely important that adequate bonds be formed between the plies of thermoplastic material and between the thermoplastic core and the paint applying medium. It is also critical that the process times for manufacturing such cores and roller cores be minimized for economic reasons.

### SUMMARY OF THE INVENTION

According to one exemplary embodiment of the present invention, a paint roller cover includes a cylindrical core and a liquid applying medium coupled to the core. The cylindrical core has an inner surface and an opposite outer surface. The core includes at least one gap between the inner surface and the outer surface.

According to another exemplary embodiment, a method for forming a paint roller includes forming a cylindrical core and including at least one layer having an inner surface, an outer surface and at least one gap between the inner surface and the outer surface and joining a liquid applying medium to the core.

According to yet another exemplary embodiment, a paint roller cover core includes a cylindrical tube including an inner surface and an opposite outer surface. The tube includes at least one gap between the inner surface and the outer surface.

### BRIEF DESCRIPTION OF THE DRAWINGS

FIG. 1 is a fragmentary perspective view of a roller including a roller cover of the present invention.

FIG. 2 is a sectional view of the roller cover of FIG. 1 taken along line 2-2.

FIG. 3 is an enlarged fragmentary view of the roller cover of FIG. 2 taken along line 3-3.

FIG. 4 is a fragmentary perspective view of an alternative embodiment of the roller cover of FIG. 1.

FIG. 5 is a sectional view of the roller cover of FIG. 4 taken along line 5-5.

FIG. 6 is an enlarged fragmentary view of the roller cover of FIG. 5 taken along line 6-6.

### DETAILED DESCRIPTION

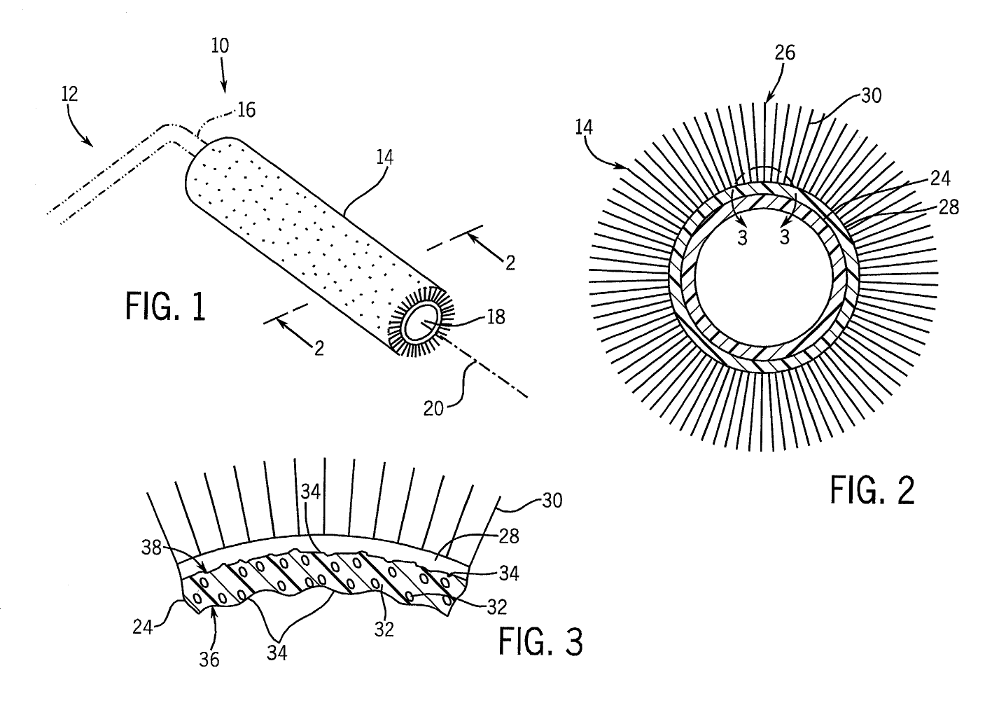

FIG. 1 illustrates an exemplary embodiment of a paint roller system 10. As shown by FIG. 1, paint roller system 10 generally includes paint roller 12 and roller cover 14. Paint roller 12 generally includes a frame 16 rotatably supporting a roller cover support 18. Roller cover support 18 preferably comprises a cage rotatably mounted upon frame 16. The cage may be formed as a single unitary body out of plastic such as disclosed and described in U.S. patent application Ser. Nos. 5,584,092 and 5,979,009, the full disclosures of which are hereby incorporated by reference, or may comprise a cage formed from a plurality of wires or metal rods such as are conventionally known in the art. Support 18 fits within roller cover 14 to rotatably support roller cover 14 about axis 20.

FIGS. 2 and 3 illustrate roller cover 14 in greater detail. FIG. 2 is a sectional view of roller cover 14 taken along lines 2-2. FIG. 3 is a greatly enlarged fragmentary view of a portion of roller cover 14 shown in FIG. 2. As shown by FIG. 2, roller cover 14 generally includes core 24 and a paint applying medium 26. Core 24 is an elongate hollow cylindrical or tubular member having an inner diameter sized to receive and frictionally engage at least portions of support 18 and an outer diameter configured to support paint applying medium 26. Paint applying medium 26 is affixed to and about core 24 and is configured to absorb, hold or temporarily retain paint or other liquid coating until being pressed against a wall or other surface to be coated. In the exemplary embodiment illustrated, paint applying medium 26 includes a thermoplastic backing 28 and a fabric nap 30 formed from polyester material. Although less desirable, backing 28 and nap 30 may be formed from other materials. For example, nap 30 may be formed from sponge, foam, or other natural or other synthetic fabrics and hairs. Moreover, nap 30 may be provided with a multitude of differently configured patterns to produce patterns upon various surfaces.

FIG. 3 illustrates roller cover 14 in greater detail. As best shown by FIG. 3, core 24 is formed from a polymeric material including a blowing agent or alternatively is processed so as to have the characteristics of a polymeric material including a blowing agent. As a result, core 24 is foamed, having a plurality of internal pockets or cells 32 and a plurality of external open pockets or craters 34 along internal surface 36 and along external surface 38. The foaming of core 24 may be closed celled or open celled, depending upon the blowing agent chosen or the processing chosen.

In one exemplary embodiment, the foaming of core 24 is performed using conventionally known blowing agents as core 24 is formed by extrusion, injection molding, compression molding or other conventional plastic fabricating processes including, but not limited to, those processes set forth in the articles “Extruding Thermoplastic Foams”, Modern Plastics Encyclopedia, Christopher Eaton, 1986-1987, pp. 243, 244 and “Foaming Agents”, Modern Plastics Encyclopedia, Raymond Shute, 1986-1987, pp. 150-154, the full disclosures of which are hereby incorporated by reference. According to another exemplary embodiment, the foaming of core 24 is achieved using the MuCell process which uses supercritical fluids of atmospheric gases, in lieu of chemical blowing agents, to create evenly distributed and uniformly sized microscopic cells throughout thermoplastic polymers. Such processes are disclosed in U.S. Pat. Nos. 6,051,174; 5,866,053; 5,334,356; 5,160,674; and 5,158,986, the full disclosures of which, in their entirety, are hereby incorporated by reference. For purposes of the disclosure, the term “blowing agent” encompasses both chemical blowing agents and supercritical fluids of atmospheric gases.

As shown in FIG. 3, the plurality of open cells or craters 34 create a rough, dimpled or cratered texture along inner surface 36 and outer surface 38. These cratered surfaces 36 and 38 enable stronger bonds to be formed between paint applying medium 26 and core 24, enable better gripping of roller cover 14 by support 18, and enable more cost effective manufacture of roller cover 14. First, craters 34 along inner surface 36 provide an increased surface area and a roughened surface having a greater coefficient or friction. As a result, craters 34 enable core 24 to be more securely retained upon support 18, avoiding accidental slippage or rotation of core 24 and roller cover 14 during the coating of paint or other liquid upon the surface. Second, craters 34 along outer surface 38 increase the surface area of outer surface 38 as compared to conventional, relatively smooth surfaces. This increased surface area provides a greater number of bonding sites between core 24 and backing 28 of paint applying medium 26. In particular, in applications where backing 28 is secured to core 24 by an adhesive such as glue or a thermoset polymeric adhesive, craters 34 provide a stronger bond between medium 26 and core 24 or enable medium 26 to be secured to core 24 with a smaller quantity of the adhesive or glue. In applications where a liquid thermoplastic material is applied or deposited between backing 28 and core 24 or in applications where surface 38 or backing 28 is heated to a temperature above its melting point so as to soften or melt the materials to fuse core 24 to backing 28, craters 34 facilitate faster melting and fusing of outer surface 38 to core 24 in addition to providing a greater number of bonding sites. As a result, not only is the bond between core 24 and paint applying medium 26 stronger, but a faster and greater manufacturing throughput of roller covers 14 can be achieved to reduce the cost of roller covers 14.

Core 24 is preferably formed either by extruding the polymeric material including a blowing agent (or processed to include internal and external cells) into a cylindrical or tubular shaped member, or by extruding, molding or otherwise forming an elongate band or ribbon of such polymeric material including a blowing agent (or processed to include the internal and external cells), wherein the band or ribbon is helically wound about a cylindrical mandrel and fused or bonded to itself or to underlying or overlying substantially similar bands to form a cylindrical core in a fashion similar to that disclosed in U.S. Pat. Nos. 5,195,242; 5,206,968; 5,398,409; and 5,468,207, the full disclosures of which, in their entirety, are hereby incorporated by reference. In one embodiment, the band would be used such that the band has overlapping edges which are bonded or fused to one another. In another embodiment, multiple bands or plies would be overlapped and secured to one another about a mandrel to form a cylindrical core. In yet another embodiment, the band would be spirally wrapped about a mandrel with adjacent edges of the band being bonded or fused to one another. Fusing the adjacent edges of the band would generally involve heating at least one of the adjacent edges to a temperature above its melting point either by flame burning, welding or other methods of heating. In such applications, the hollow cells can facilitate faster melting and process times. Bonding adjacent edges of the band to one another would involve applying a liquid adhesive between the adjacent edges. In one embodiment, liquid adhesive would be applied to adjacent surfaces 36 and 38 along the seams provided by the adjacent abutting edges of the band. In another embodiment, the adhesive would be applied between the edges of the adjacent bands between surfaces 36 and 38. In a preferred embodiment, the adhesive comprises a solvent resistant polymeric adhesive which is a thermoset adhesive or a thermoplastic adhesive. In the exemplary embodiment, the adhesive comprises a liquid thermoplastic polypropylene or polyethylene which is deposited between adjacent edges of a spirally wrapped band just prior to the edges being positioned in a completely abutting relationship. In yet another alternative embodiment, the band or bands are wrapped about a mandrel so as to form a gap between adjacent edges of the band, wherein the gap is filled with a liquid polymeric material which, upon solidifying, joins adjacent wraps of the band.

In conclusion, the paint roller covers and paint rollers in general include a polymeric core material including a plurality of internal cells or pockets and a plurality of external craters. The paint roller covers and paint rollers preferably include a polymeric core which is formed using a blowing agent. Lastly, methods and processes for forming paint rollers and paint roller covers are disclosed in which the core of the cover is formed using a blowing agent to provide the core with external craters.

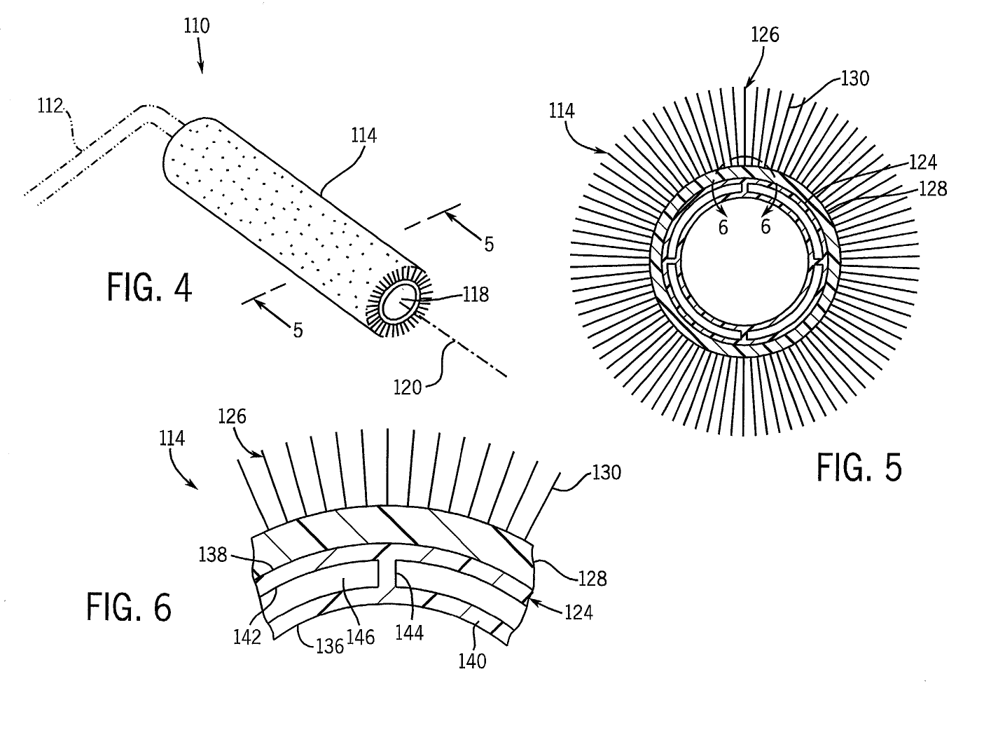

FIG. 4 illustrates an exemplary embodiment of a paint roller system 110, an alternative embodiment of system 10. As shown by FIG. 4, paint roller system 110 generally includes paint roller 112 and roller cover 114. Paint roller 112 generally includes a frame 116 rotatably supporting a roller cover support 118. Roller cover support 118 preferably comprises a cage rotatably mounted upon frame 116. The cage may be formed as a single unitary body out of plastic such as disclosed and described in U.S. patent application Ser. Nos. 5,584,092 and 5,979,009 (full disclosures of which, in their entirety, are hereby incorporated by reference) or may comprise a cage formed from a plurality of wires or metal rods such as are conventionally known in the art. Support 118 fits within roller cover 114 to rotatably support roller cover 114 about axis 120.

FIGS. 5 illustrates roller cover 114 in greater detail. FIG. 5 is a sectional view of roller cover 114 taken along lines 5-5. As shown by FIG. 5, roller cover 114 generally includes core 124 and a paint applying medium 126. Core 124 is an elongate hollow cylindrical or tubular member having an inner diameter sized to receive and frictionally engage at least portions of support 118 and an outer diameter configured to support paint applying medium 126. Paint applying medium 126 is affixed to and about core 124 and is configured to absorb, hold or temporarily retain paint or other liquid coating until being pressed against a wall or other surface to be coated. In the exemplary embodiment illustrated, paint applying medium 126 includes a thermoplastic backing 128 and a fabric nap 130 formed from polyester material. Although less desirable, backing 128 and nap 130 may be formed from other materials. For example, nap 130 may be formed from sponge, foam, or other natural or other synthetic fabrics and hairs. Moreover, nap 130 may be provided with a multitude of differently configured patterns to produce patterns upon various surfaces.

FIG. 6 illustrates roller cover 114 in greater detail. As best shown by FIG. 6, roller 124 is generally hollow, including one or more gaps or cavities between inner surface 136 and outer surface 138. In the exemplary embodiment, core 124 includes an inner layer 140, an outer layer 142 and at least one interconnecting rib 144. Layers 140 and 142 are extremely thin and lightweight. Layer 142 provides exterior surface 138 against which backing 128 of liquid applying material 126 is fused or adhered. Layer 140 provides inner surface 136 which supports cover 114 upon support 118 of frame 112. Rib 144 extends between layers 140 and 142 and is preferably integrally formed as part of a single unitary body with layers 140 and 142. Rib 144 supports and spaces layers 140 and 142 relative to one another so as to form an internal gap 146. Gap 146 extends between layers 140 and 142 generally parallel to surfaces 136 and 138 circumferentially about the axis of cover 114. Gap 146 provides roller cover 114 with several desirable attributes. First, gap 146 reduces the weight of roller cover 114, allowing paint roller system 110 to be used for prolonged periods of time with less fatigue. Second, gap 146 reduces the quantity of material required to form core 124, reducing the costs of cover 114. Third, gap 146 increases the outer diameter of core 124, enabling cover 114 and paint applying medium 126 to also have a larger outer diameter. As a result, paint applying medium 126 and cover 114 are capable of carrying and applying a greater amount of paint or other liquid coating to a surface during a single revolution, allowing coating projects to be completed more quickly.

Because gap 146 extends generally parallel to surfaces 136 and 138 between layers 140 and 142, gap 146 does not reduce the overall surface area of surfaces 136 and 138. Consequently, gap 146 does not reduce the available surface 136 for frictionally engaging support 118 and also does not reduce the available surface 138 for bonding with backing 128 of liquid applying medium 126. Although less desirable, gap 146 may alternatively extend completely through core 124 in a direction non-parallel to surfaces 136 and 138 such that gap 146 extends through layers 140 and 142. Moreover, in lieu of the illustrated configuration of ribs 144 and gaps 146, core 124 may alternatively have any of a variety of alternative configurations. For example, ribs 144 and gaps 146 may be honeycombed or might have multiple levels of hollow gaps 146 extending parallel to or non-parallel to surfaces 136 and 138. The relative thickness and number of ribs 144 may be varied depending upon the materials chosen for core 124, the thickness of layers 140 and 142 and the quantity and spacing of ribs 144.

In the embodiment illustrated in FIG. 6, core 124 is formed by extruding a single elongate cylindrical or tubular core 124 having layers 140, 142 and ribs 144. Alternatively, core 124 having layers 140, 142 and ribs 144 may be formed by other manufacturing methods. Moreover, core 124 may alternatively be formed by extruding or otherwise forming one or more elongate bands or ribbons, each band or ribbon having layers 140, 142 and ribs 144. The elongate band or ribbon would then be helically wound about a cylindrical mandrel and fused or bonded to itself or to underlying or overlying similar bands to form a cylindrical core in a fashion similar to that disclosed in U.S. Pat. Nos. 5,195,242; 5,206,968; 5,398,409; and 5,468,207, the full disclosures of which, in their entirety, are hereby incorporated by reference. In one embodiment, the band would be used such that the band has overlapping edges which are bonded or fused to one another. In another embodiment, multiple bands or plies would be overlapped and secured to one another about a mandrel to form a cylindrical core. In another embodiment, a band would be spirally wrapped about a mandrel with the adjacent edges of the band being bonded or fused to one another. Fusing the adjacent edges of the band would generally involve heating at least one of the adjacent edges to a temperature above its melting point either by flame burning, welding or other methods of heating. In such applications, the generally hollow nature of the edges of the band facilitate faster melting and process times. Bonding adjacent edges of the band to one another would involve applying a liquid adhesive between the adjacent edges. In one embodiment, the liquid adhesive would be applied to surfaces 136 and 138 along the seams provided by the adjacent abutting edges of the band. In another embodiment, the adhesive would be applied between the edges of the adjacent bands between surfaces 136 and 138. According to one exemplary method, the adhesive would be applied along the seam between adjacent bands such that the adhesive is positioned in gap 146 while spanning or extending across the seam to surely join the adjacent wraps of the band internally. In a preferred embodiment, the adhesive comprises a solvent resistant polymeric adhesive which is a thermoset adhesive or a thermoplastic adhesive. In an exemplary embodiment, the adhesive comprises a liquid thermoplastic polypropylene or polyethylene which is deposited between opposing edges of a spirally wrapped band just prior to the edges being positioned in a completely abutting relationship. As a result, a liquid thermoplastic adhesive flows into gap 146 adjacent the seam of both adjacent wraps and bonds to those surfaces of the band bounding gap 146. Upon being cooled, the thermoplastic adhesive forms a secure bond between adjacent wraps of the band. In the noted exemplary embodiment, the band itself is preferably formed from a polymeric material compatible with the polymeric adhesive. For example, in one exemplary embodiment, both the band and the liquid polymeric adhesive are formed from polypropylene. In yet another alternative embodiment, the band or bands are wrapped around a mandrel so as to form a gap between adjacent edges of the band, wherein the gap is filled with a liquid polymeric material which upon solidifying joins adjacent wraps of the band.

In conclusion, paint roller covers and paint rollers in general including a core having internal gaps are disclosed. In particular embodiments, gaps extend between the inner and outer surfaces of the core. In other embodiments, gaps extend through the inner and outer surfaces of the core. Methods and processes for forming paint rollers and paint roller covers are further disclosed in which the core or the cover is formed so as to have the aforementioned gap or cavity.

Although the present invention has been described with reference to preferred embodiments, workers skilled in the art will recognize that changes may be made in form and detail without departing from the spirit and scope of the invention. For example, although different preferred embodiments may have been described as including one or more features providing one or more benefits, it is contemplated that the described features may be interchanged with one another or alternatively be combined with one another in the described preferred embodiments or in other alternative embodiments. Because the technology of the present invention is relatively complex, not all changes in the technology are foreseeable. The present invention described with reference to the preferred embodiments and set forth in the following claims is manifestly intended to be as broad as possible. For example, unless specifically otherwise noted, the claims reciting a single particular element also encompass a plurality of such particular elements.

What is claimed is:

1. A paint roller cover comprising:
a cylindrical core having an inner surface and an opposite outer surface, wherein the core includes at least one gap between the inner surface and the outer surface; and
a liquid applying medium coupled to the core.

2. The cover of claim 1, wherein the core includes at least one continuous band, the at least one continuous band providing the inner surface, the outer surface and the at least one gap therebetween.

3. The cover of claim 1, wherein the at least one gap includes a plurality of closed cells.

4. The cover of claim 1, wherein the at least one gap includes a plurality of open cells.

5. The cover of claim 1 including at least one rib extending across the at least one gap.

6. The cover of claim 1 including a plurality of craters on at least one of the inner surface and the outer surface.

7. The cover of claim 6 including a plurality of open cells along said at least one of the inner surface and the outer surface, wherein the plurality of open cells form the plurality of craters.

8. The cover of claim 1, wherein the liquid applying medium is selected from a group of materials including: sponge, foam, synthetic fabrics, natural fabrics and hairs.

9. The cover of claim 1, wherein the liquid applying medium includes a nap and a backing coupled to the nap and to the outer surface of the core.

10. The cover of claim 9, wherein the outer surface includes portions which are fused to the backing.

11. The cover of claim 9, wherein at least portions of the backing include at least one thermoplastic material.

12. The cover of claim 1, wherein the liquid applying medium is fused to the outer surface of the core.

13. The cover of claim 1, wherein at least portions of the outer surface of the core include at least one thermoplastic material.

14. The cover of claim 1, wherein the core is formed from at least one polymeric material and at least one blowing agent.

15. The cover of claim 14, wherein the at least one blowing agent includes a chemical blowing agent.

16. The cover of claim 14, wherein the at least one blowing agent includes at least one supercritical fluid of an atmospheric gas.

17. The cover of claim 1, wherein the at least one layer is formed from at least one polymeric material.

18. A method for forming a paint roller, the method comprising:
forming a cylindrical core including at least one layer having an inner surface, an outer surface and at least one gap between the inner surface and the outer surface; and
joining a liquid applying medium to the core.

19. The method of claim 18, wherein the step of forming a cylindrical core includes extruding the cylindrical core.

20. The method of claim 18, wherein forming a cylindrical core includes extruding a band providing the at least one layer and forming the band into the cylindrical core.

21. The method of claim 20 including helically wrapping the band about a mandrel to form the band into the cylindrical core.

22. The method of claim 18, wherein the at least one layer is formed from a polymeric material including a blowing agent.

23. The method of claim 18, wherein the cylindrical core has an exterior surface and wherein the method includes forming a plurality of craters on the exterior surface.

24. The method of claim 18 including forming a plurality of cells between the inner surface and the outer surface.

25. The method of claim 18 including forming a first plurality of cells between the inner surface and the outer surface and a second plurality of open cells along the outer surface.

26. The method of claim 18 including fusing the core and a liquid applying medium together.

27. The method of claim 18 including applying an adhesive between the core and the liquid applying medium.

28. The method of claim 27, wherein the adhesive comprises a thermoplastic polymeric material.

29. The method of claim 26, wherein the adhesive comprises a thermoset polymeric material.

30. A paint roller cover core comprising:
a cylindrical tube having an inner surface and an opposite outer surface, wherein the tube includes at least one gap between the inner surface and the outer surface.

31. The core of claim 30, wherein the at least one gap includes a first plurality of cells between the inner surface and the outer surface.

32. The core of claim 31, wherein the tube includes a second plurality of open cells along at least one of the inner surface and the outer surface.

33. The core of claim 32, wherein the second plurality of open cells extends along both the inner surface and the outer surface.

34. The core of claim 33, wherein the tube has an inner diameter configured to receive and frictionally engage a paint roller cage.

35. The core of claim 30, wherein the tube has an inner diameter configured to receive and frictionally engage a paint roller cage.

36. The core of claim 30, wherein the cylindrical tube is formed from at least one polymeric material.

37. The core of claim 36, wherein the at least one polymeric material includes at least one blowing agent.
